(19) United States
(12) Patent Application Publication
(10) Pub. No.: US 2014/0025930 A1
(43) Pub. Date: Jan. 23, 2014

(54) MULTI-CORE PROCESSOR SHARING LI CACHE AND METHOD OF OPERATING SAME

(71) Applicant: Samsung Electronics Co., Ltd., Suwon-si (KR)

(72) Inventors: HOI JIN LEE, SEOUL (KR); NAK HEE SEONG, GWACHEON-SI (KR); JAE HONG PARK, SEONGNAM-SI (KR); KYOUNG MOOK LIM, HWASEONG-SI (KR)

(73) Assignee: Samsung Electronics Co., Ltd., Suwon-si (KR)

(21) Appl. No.: 14/037,543

(22) Filed: Sep. 26, 2013

Related U.S. Application Data
(63) Continuation-in-part of application No. 13/713,088, filed on Dec. 13, 2012.

(30) Foreign Application Priority Data
Feb. 20, 2012 (KR) 10-2012-0016746

(51) Int. Cl. G06F 9/30

(52) U.S. Cl. CPC G06F 9/30058
USPC 712/205

(57) ABSTRACT

A multi-core processor includes first processor core including a first instruction fetch unit and out-of-order execution data units, a second processor core including a second instruction fetch unit and in-order execution data units, and a shared-level 1 cache including a level 1-instruction cache shared between the first instruction fetch unit and the second instruction fetch unit and a level 1-data cache shared between the out-of-order execution data units and the in-order execution data.

### CROSS-REFERENCE TO RELATED APPLICATIONS

This application claims priority under 35 U.S.C. §119(a) from Korean Patent Application No. 10-2012-0016746 filed on Feb. 20, 2012, the subject matter of which is hereby incorporated by reference.

### BACKGROUND

The present inventive concept relates to multi-core processors, and more particularly, to multi-core processors including a plurality of processor cores sharing a level 1 (L1) cache, and devices having same.

To improve performance of a system on chip (SoC), certain circuits and/or methods that effectively increase the operating frequency of a central processing unit (CPU) within the SoC has been proposed. One approach to increasing the operating frequency of the CPU increases a number of pipeline stages.

One technique referred to as dynamic frequency and voltage scaling (DVFS) has been successfully used to reduce power consumption in computational systems, particularly those associated with mobile devices. However, under certain workload conditions, the application of DVFS to a CPU has proved inefficient.

### SUMMARY

Certain embodiments of the inventive concept are directed to multi-core processors, including; a first processor core including a first instruction fetch unit and out-of-order execution data units, a second processor core including a second instruction fetch unit and in-order execution data units, and a shared-level 1 cache including a level 1-instruction cache shared between the first instruction fetch unit and the second instruction fetch unit and a level 1-data cache shared between the out-of-order execution data units and the in-order execution data units.

Certain embodiments of the inventive concept are directed to a multi-core processor including; a first processor core including a first instruction fetch unit and out-of-order execution data units; a second processor core including a second instruction fetch unit and in-order execution data units, a shared-level 1 cache including a level 1-instruction cache shared between the first instruction fetch unit and the second instruction fetch unit and a level 1-data cache shared between the out-of-order execution data units and the in-order execution data units, and a power management unit that selectively provides a first power signal to the first processor core, selectively provides a second power signal to the second processor core, and provides a third power signal to the shared-level 1 cache.

Certain embodiments of the inventive concept are directed to a system comprising: a bus interconnect connecting a slave device with a virtual processing device, wherein the virtual processing device comprises; a first multi-core processor group having a first level-1 cache, a second multi-core processor group having a second level-1 cache, a selection signal generation circuit, wherein a first output is provided by the first level-1 cache in response to a first selection signal provided by the selection signal generation circuit, and a second output is provided by the second level-1 cache in response to a second selection signal provided by the selection signal generation circuit, and a level-2 cache that receives the first output from the first level-1 cache and the second outputs from the second level-1 cache, and provides a virtual processing core output to the bus interconnect.

Certain embodiments of the inventive concept are directed to a method of operating a multi-core processor, the method comprising; generating a first control signal from a first processor core including a first instruction fetch unit and out-of-order execution data units, generating a second control signal from a second processor core including a second instruction fetch unit and in-order execution data units, sharing a level 1-instruction cache of a single shared level-1 cache between the first instruction fetch unit and the second instruction fetch unit and sharing a level 1-data cache of the shared level-1 cache between the out-of-order execution data units and the in-order execution data units.

### BRIEF DESCRIPTION OF THE DRAWINGS

These and/or other aspects and advantages of the inventive concept will become apparent and more readily appreciated from the following description of the embodiments, taken in conjunction with the accompanying drawings of which:

FIG. 1 is a block diagram illustrating a multi-core processor sharing a level 1 (L1) cache according to an embodiment of the inventive concept;

FIG. 2 is a block diagram illustrating a multi-core processor sharing a L1 cache according to another embodiment of the inventive concept;

FIG. 3 is a block diagram illustrating a multi-core processor sharing a L1 cache according to still another embodiment of the inventive concept;

FIG. 4 is a block diagram illustrating a multi-core processor sharing a L1 cache according to still another embodiment of the inventive concept;

FIG. 5 is a block diagram illustrating a multi-core processor sharing a L1 cache according to still another embodiment of the inventive concept;

FIG. 6 is a general flowchart summarizing operation of the multi-core processor illustrated in any one of FIGS. 1, 2, 3, 4, and 5;

FIG. 7 is a block diagram illustrating a multi-core processor sharing a L1 cache according to still another embodiment of the inventive concept;

FIG. 8 is a block diagram further illustrating the multi-core processor of FIG. 7;

FIG. 9 is a flowchart summarizing a core switch method that may be used by multi-core processor of FIG. 7;

FIG. 10 is a block diagram illustrating a system including the multi-core processor of FIG. 7 according to certain embodiments of the inventive concept;

FIG. 11 is a block diagram illustrating a data processing device including the multi-core processor illustrated in any one of FIGS. 1, 2, 3, 4, 5 and 7;

FIG. 12 is a block diagram illustrating another data processing device including the multi-core processor illustrated in any one of FIGS. 1, 2, 3, 4, 5 and 7; and

FIG. 13 is a block diagram illustrating yet another data processing device including the multi-core processor illustrated in any one of FIGS. 1, 2, 3, 4, 5 and 7.

### DETAILED DESCRIPTION

Certain embodiments of the present inventive concept now will now be described in some additional detail with reference to the accompanying drawings. The inventive concept may, however, be embodied in many different forms and should not be construed as being limited to only the illustrated embodiments. Rather, these embodiments are provided so that this disclosure will be thorough and complete, and will fully convey the scope of the invention to those skilled in the art. Throughout the written description and drawings, like reference numbers and label are used to denote like or similar elements.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

Each of a plurality of processor cores integrated in a multi-core processor according to an embodiment of the inventive concept may physically share a “level 1” (L1) cache.

Accordingly, since each of the plurality of processor cores physically shares the L1 cache, the multi-core processor may perform switching or CPU scaling between the plurality of processor cores without increasing a switching penalty while performing a specific task.

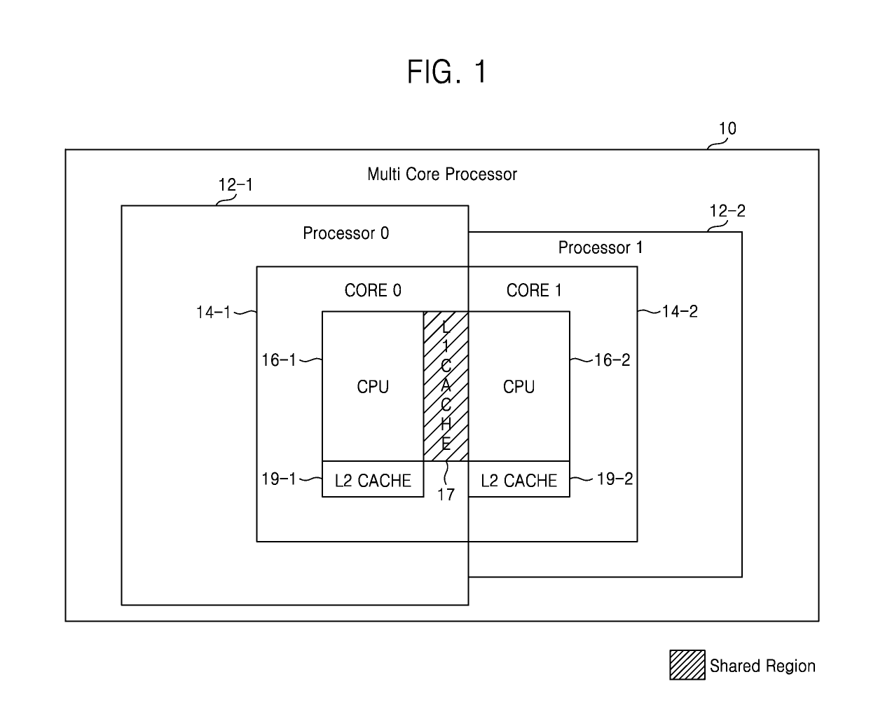

FIG. 1 is a block diagram illustrating a multi-core processor sharing an L1 cache according to an embodiment of the inventive concept. Referring to FIG. 1, a multi-core processor 10 includes two processors 12-1 and 12-2. Accordingly, the multi-core processor 10 may be called a dual-core processor.

A first processor 12-1 includes a processor core 14-1. The processor core 14-1 includes a CPU 16-1, a level 1 cache (hereinafter, called ‘L1 cache’) 17, and a level 2 cache (hereinafter, called ‘L2 cache’) 19-1. The L1 cache 17 may include an L1 data cache and an L1 instruction cache. A second processor 12-2 includes a processor core 14-2. The processor core 14-2 includes a CPU 16-2, the L1 cache 17 and an L2 cache 19-2.

Here, the L1 cache 17 is shared by the processor core 14-1 and the processor core 14-2. The L1 cache 17 may be integrated or embedded in a processor operating at a comparably high operating frequency among the two processor cores 14-1 and 14-2, e.g., the processor core 14-1.

The operating frequency for each independent processor core 14-1 and 14-2 may be different. For example, an operating frequency of the processor core 14-1 may be higher than an operating frequency of the processor core 14-2.

It is assumed that the processor core 14-1 is a processor core that maximizes performance even though workload performance capability (as measured, for example using a Microprocessor without Interlocked Pipeline Stages (MIPS)/mW scale) per unit power consumption under a relatively high workload is low. It is further assumed that the processor core 14-2 is a processor core that maximizes workload performance capability (MIPS/mW) per unit power consumption even though maximum performance under a relatively low workload is low.

In the illustrated example of FIG. 1, each processor core 14-1 or 14-2 includes an L2 cache 19-1 or 19-2. However, in other embodiments, each processor core 14-1 or 14-2 may share a single L2 cache. Further, while each processor core 14-1 or 14-2 is illustrated as incorporating a separate L2 cache, the L2 caches may be provided external to each processor core 14-1 or 14-2.

As the L1 cache 17 is shared, the processor core 14-2 may transmit data to the L1 cache while executing a specific task. Accordingly, the processor core 14-2 may acquire control over the L1 cache 17 from the processor core 14-1 while executing the specific task. The specific task may be, for example, execution of a program. Moreover, as the L1 cache 17 is shared, the processor 14-1 may transmit data to the L1 cache 17 while executing a specific task. Accordingly, the processor core 14-1 may acquire control over the L1 cache 17 from the processor 14-2 while executing a specific task.

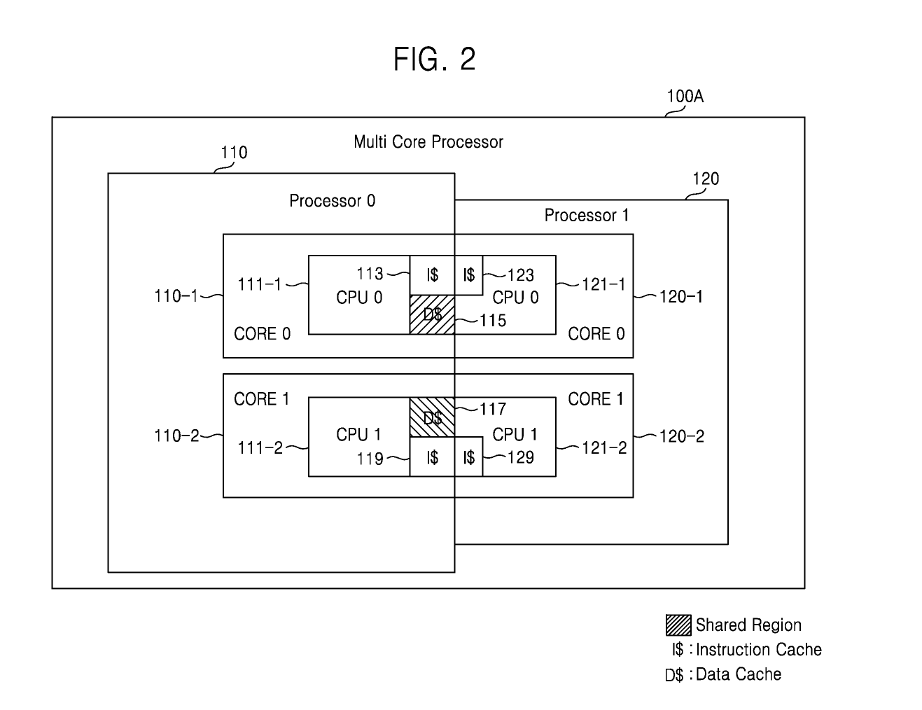

FIG. 2 is a block diagram illustrating a multi-core processor sharing the L1 cache according to another embodiment of the inventive concept. Referring to FIG. 2, a multi-core processor 100A includes two processors 110 and 120.

The first processor 110 includes a plurality of processor cores 110-1 and 110-2. A first processor core 110-1 includes a CPU 111-1, an L1 instruction cache 113, and an L1 data cache 115. A second processor core 110-2 includes a CPU 111-2, an L1 data cache 117 and an L1 instruction cache 119.

The second processor 120 includes a plurality of processor cores 120-1 and 120-2. A third processor core 120-1 includes a CPU 121-1, an L1 instruction cache 123, and an L1 data cache 115. Here, the L1 data cache 115 is shared by each processor core 110-1 and 120-1. According to an example embodiment, the L1 data cache 115 is embedded in or integrated to the first processor core 110-1 having a relatively high operating frequency.

A fourth processor core 120-2 includes a CPU 121-2, the L1 data cache 117, and an L1 instruction cache 129. Here, the L1 data cache 117 is shared by each processor core 110-2 or 120-2. According to an example embodiment, the L1 data cache 117 is embedded in or integrated to the second processor core 110-2 having a relatively high operating frequency.

For example, when the first processor 110 includes a plurality of processor cores 110-1 and 110-2, the second processor 120 includes a plurality of processor cores 120-1 and 120-2, and the L1 data cache 115 is not shared, CPU scaling or CPU switching may be performed as follows. That is, CPU scaling or CPU switching is performed in a following order: the processor core 120-1→the plurality of processor cores 120-1 and 120-2→the processor core 110-1→the plurality of processor cores 110-1 and 110-2. Here, when switching is performed from the plurality of processor cores 120-1 and 120-2 to the processor core 110-1, a switching penalty (again, as may be measured using a MIPS/mW scale) increases considerably.

However, as illustrated in FIG. 2, when each L1 data cache 115 and 117 is shared, CPU scaling or CPU switching may be performed as follows.

CPU scaling or CPU switching may be performed in a following order: the processor core 120-1→the plurality of processor cores 120-1 and 120-2→the plurality of processor cores 110-1 and 110-2.

Since each L1 data cache 115 and 117 is shared, CPU scaling or CPU switching from the plurality of processor cores 120-1 and 120-2 to the processor core 110-1 may be skipped.

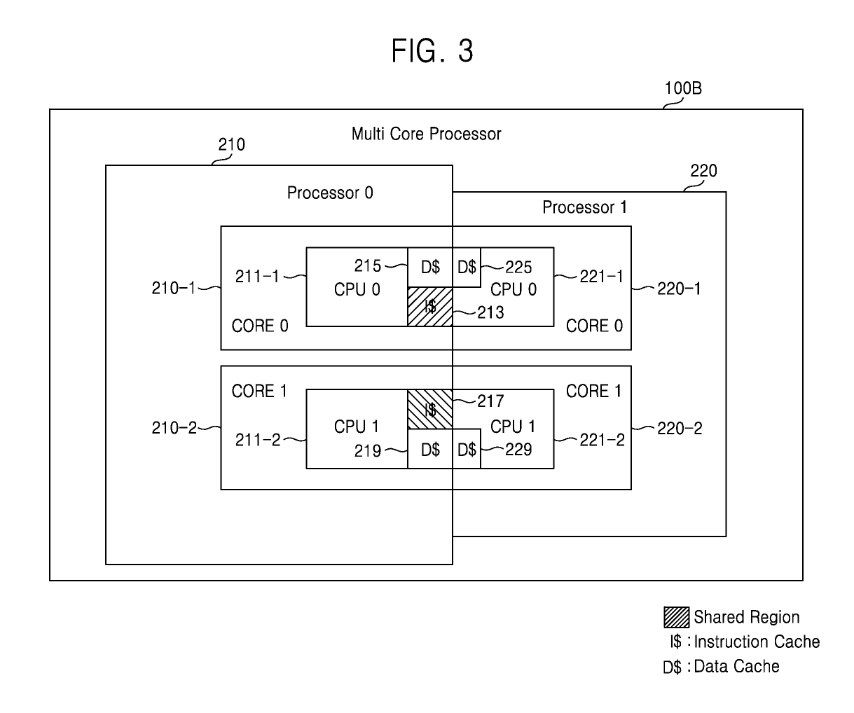

FIG. 3 is a block diagram illustrating a multi-core processor sharing the L1 cache according to still another embodiment of the inventive concept. Referring to FIG. 3, a multi-core processor 100B includes two processors 210 and 220.

A first processor 210 includes a plurality of processor cores 210-1 and 210-2. A first processor core 210-1 includes a CPU 211-1, an L1 data cache 215 and an L1 instruction cache 213. A second processor core 210-2 includes a CPU 211-2, an L1 instruction cache 217 and an L1 data cache 219.

A second processor 220 includes a plurality of processor cores 220-1 and 220-2. A third processor core 220-1 includes a CPU 221-1, an L1 data cache 225, and an L1 instruction cache 213. Here, the L1 instruction cache 213 is shared by each processor core 210-1 and 220-1. According to an example embodiment, the L1 instruction cache 213 is embedded in or integrated to a first processor core 210-1 whose operating frequency is relatively high. A fourth processor core 220-2 includes a CPU 221-2, the L1 instruction cache 217 and an L1 data cache 229. Here, the L1 instruction cache 217 is shared by each processor core 210-2 and 220-2. According to the illustrated embodiment of FIG. 3, the L1 instruction cache 217 is embedded in or integrated to a second processor core 210-2 whose operating frequency is relatively high.

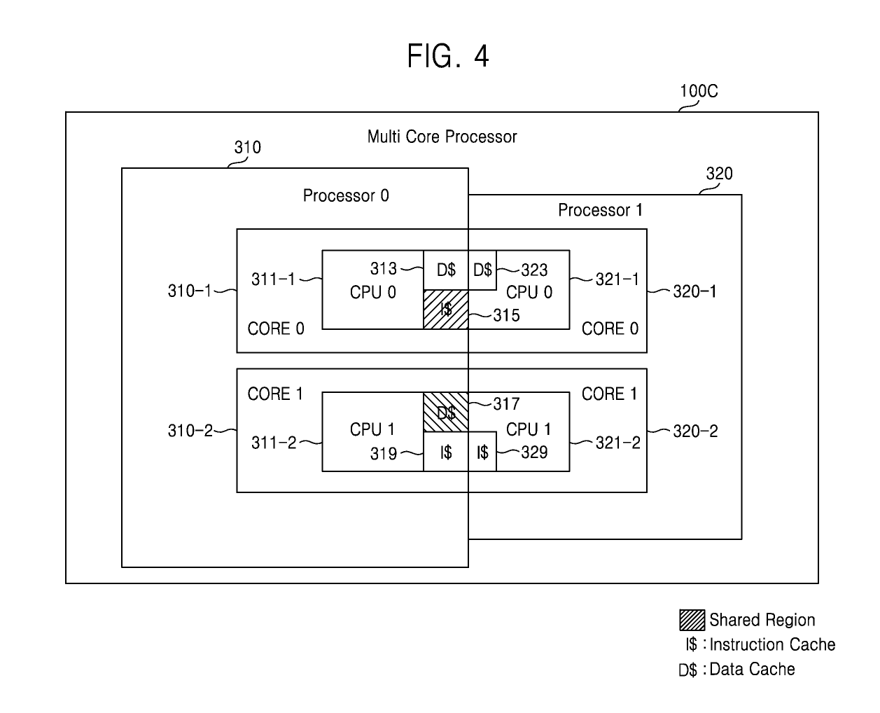

FIG. 4 is a block diagram illustrating a multi-core processor sharing an L1 cache according to still another embodiment of the inventive concept. Referring to FIG. 4, a multi-core processor 100C includes two processors 310 and 320.

A first processor 310 includes a plurality of processor cores 310-1 and 310-2. A first processor core 310-1 includes a first CPU 311-1, an L1 data cache 313 and an L1 instruction cache 315. A second processor core 310-2 includes a CPU 311-2, an L1 data cache 317 and an L1 instruction cache 319.

A second processor 320 includes a plurality of processor cores 320-1 and 320-2. A third processor core 320-1 includes a CPU 321-1, an L1 data cache 323 and the L1 instruction cache 315. Here, the first L1 instruction cache 315 is shared by each processor core 310-1 and 320-1. According to an example embodiment, the first L1 instruction cache 315 is embedded in or integrated into the first processor core 310-1 whose operating frequency is relatively high. A fourth processor core 320-2 includes a CPU 321-2, the L1 data cache 317 and an L1 instruction cache 329. Here, the L1 data cache 317 is shared by each processor core 310-2 and 320-2. According to the illustrated embodiment of FIG. 4, the L1 data cache 317 is embedded in or integrated into the second processor core 310-2 whose operating frequency is relatively high.

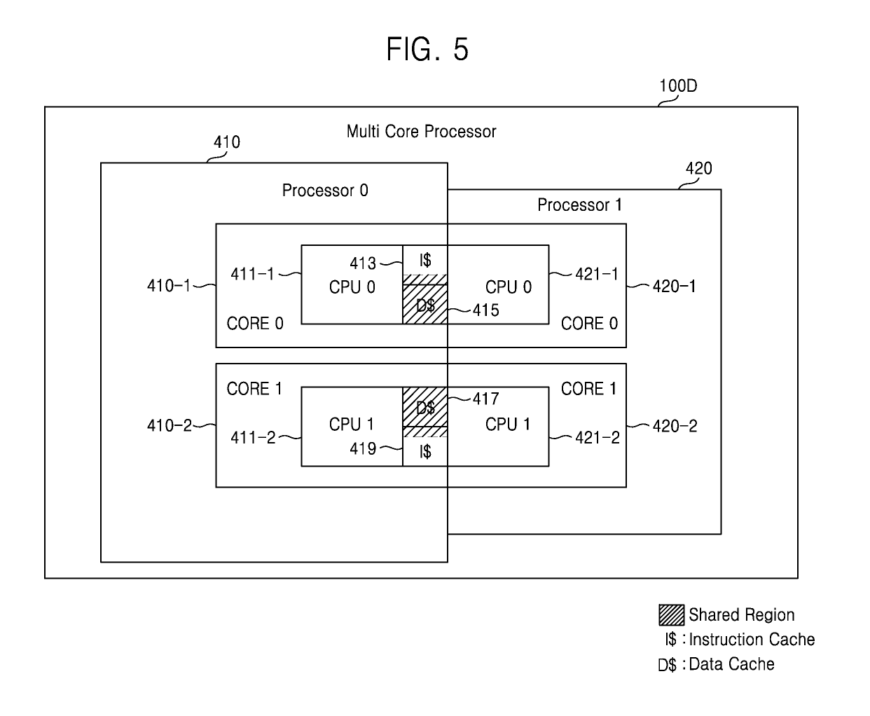

FIG. 5 is a block diagram illustrating a multi-core processor sharing an L1 cache according to still another embodiment of the inventive concept. Referring to FIG. 5, a multi-core processor 100D includes two processors 410 and 420.

A first processor 410 includes a plurality of processor cores 410-1 and 410-2. A first processor core 410-1 includes a CPU 411-1, an L1 instruction cache 413 and an L1 data cache 415. A second processor core 410-2 includes a CPU 411-2, an L1 data cache 417 and an L1 instruction cache 419.

A second processor 420 includes a plurality of processor cores 420-1 and 420-2. A third processor core 420-1 includes a CPU 421-1, an L1 instruction cache 413 and the L1 data cache 415. Here, at least one part of the L1 instruction cache 413 is shared by each processor core 410-1 and 420-1, and at least one part of the L1 data cache 415 is shared by each processor core 410-1 and 420-1. According to the illustrated embodiment of FIG. 5, the L1 instruction cache 413 and the L1 data cache 415 are embedded in or integrated to the first processor core 410-1 whose operating frequency is relatively high. A fourth processor core 420-2 includes a CPU 421-2, the L1 data cache 417 and an L1 instruction cache 419. Here, at least one part of the L1 data cache 417 is shared by each processor core 410-2 and 420-2, and at least one part of the L1 instruction cache 419 is shared by each processor core 410-2 and 420-2. According to the illustrated embodiment of FIG. 4, the L1 data cache 417 and the L1 instruction cache 419 are embedded in or integrated to the second processor core 410-2 whose operating frequency is relatively high.

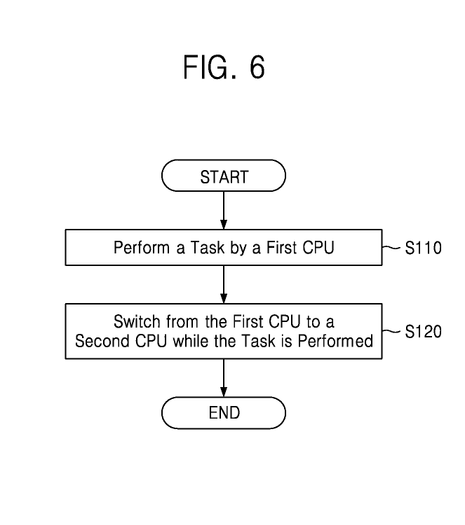

FIG. 6 is a general flowchart summarizing operation of a multi-core processor like the ones described above in relation to FIGS. 1 to 5. Referring to FIGS. 1 to 6, since a processor 12-2, 120, 220, 320 or 420 whose operating frequency is relatively low may access or use an L1 cache 17, 115 and 117, 213 and 217, 315 and 317, 413 and 415 or 417 and 419 integrated to a processor 12-1, 110, 210, 310 or 410 whose operating frequency is relatively high, performance of the processor 12-2, 120, 220, 320, or 420 whose operating frequency is relatively low may be improved.

Since the L1 cache is shared, the processor 12-2, 120, 220, 320 or 420 whose operating frequency is relatively low may transmit data by using the L1 cache during switching between processors. This makes it possible to switch from the processor 12-2, 120, 220, 320 or 420 whose operating frequency is relatively low to the processor 12-1, 110, 210, 310 or 410 whose operating frequency is relatively high during a specific task.

For example a specific task may be performed by a CPU embedded in the processor 12-2, 120, 220, 320 or 420 whose operating frequency is low (S110). While the specific task is performed by the CPU, since the L1 cache is shared, it is possible to switch from the low operating frequency CPU to a CPU embedded in the processor 12-1, 110, 210, 310 or 410 whose operating frequency is high (S 120).

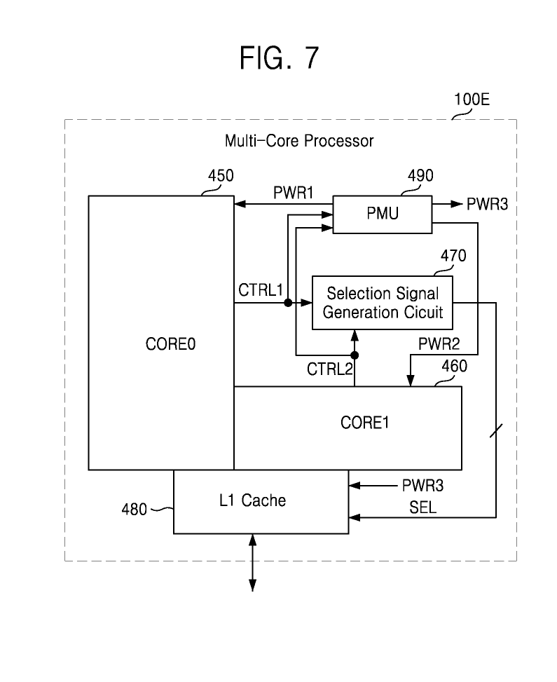

FIG. 7 is a block diagram illustrating a multi-core processor sharing a L1 cache according to still another embodiment of the inventive concept.

Referring to FIG. 7, a multi-core processor 100E may be used as a virtual processing core embodied by the combination of two (2) heterogeneous processor cores 450 and 460. The two heterogeneous processor cores 450 and 460 may be physically separated within the multi-core processor 100E.

In certain embodiments of the inventive concept, a first processor core 450 may have a relatively wider pipeline than a second processor core 460, and may also operate at a relatively higher performance level. Thus, while the second processor core 460 uses a narrower pipeline and operates at a relatively lower performance level, it also consumes relatively less power.

The multi-core processor 100E further includes a selection signal generation circuit 470 that generates a selection signal SEL that may be used to control core switching between the first and second processor cores 450 and 460. In this context, the selection signal SEL may take various forms and may include one or more discrete control signals.

For example, the selection signal generation circuit 470 may be used to generate the selection signal SEL in response to a first control signal CTRL1 provided by the first processor core 450 and/or in response to a second control signal CTRL2 provided by the second processor core 460. However generated, the selection signal SEL may be provided to a shared-L1 cache 480.

According to the illustrated embodiment of FIG. 7, the selection signal generation circuit 470 may be embodied by one or more control signal registers. The control signal registers may be controlled by a currently operating one of the first processor core 450 and the second processor core 460. That is, a currently operating processor core may set values for the control signal registers.

As noted above, the multi-core processor 100E of FIG. 7 includes the shared-L1 cache 480 which is shared by the first processor core 450 and the second processor core 460.

The multi-core processor 100E may further include a power management unit (PMU) 490. The PMU 490 may be used to control each one of a number of power signals (e.g., PWR1, PWR2, and PWR3) variously supplied to one or more of the first processor core 450, the second processor core 460, and the shared-L1 cache 480.

For example, the PMU 490 may control each supply of the powers PWR1, PWR2, and PWR3 in response to the first control signal CTRL1 output from the first processor core 450 and/or the second control signal CTRL2 output from the second processor core 460.

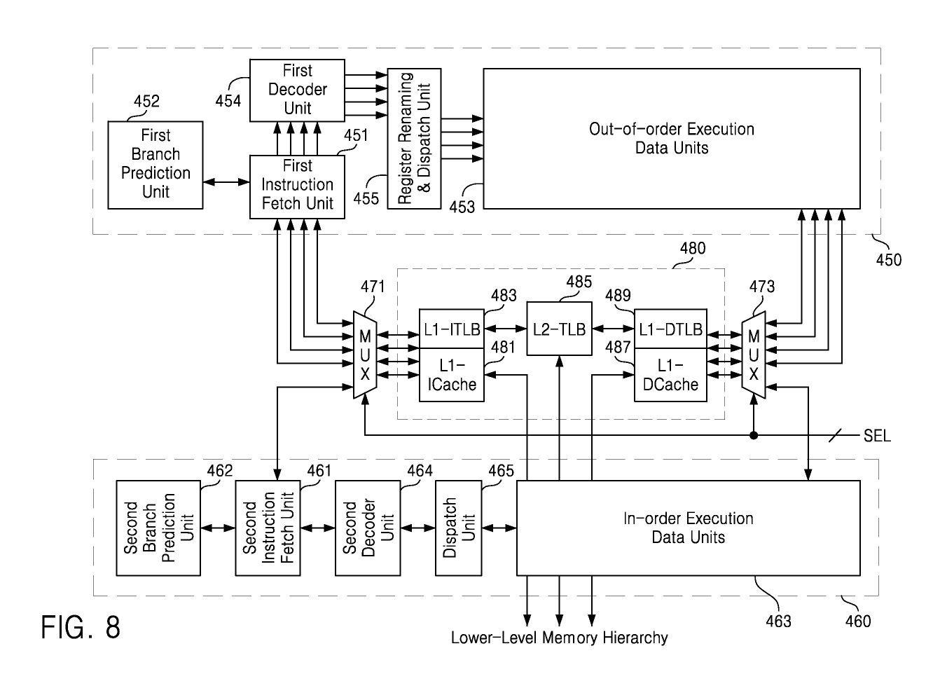

FIG. 8 is a block diagram further illustrating in one embodiment the multi-core processor of FIG. 7.

Referring to FIGS. 7 and 8, the first processor core 450 comprises a first branch prediction unit 452, a first instruction fetch unit 451, a first decoder unit 454, a register renaming & dispatch unit 455, and out-of-order execution data units 453.

The out-of-order execution data units 453 may include conventionally understood arithmetic and logic units (ALUs), multipliers, dividers, branches, load and store units, and/or floating point units.

The second processor core 460 comprises a second branch prediction unit 462, a second instruction fetch unit 461, a second decoder unit 464, a dispatch unit 465, and in-order execution data units 463.

The in-order execution data units 463 may also include conventionally understood ALUs, multipliers, dividers, branches, load and store units, and/or floating point units.

Hereafter, an exemplary approach to switching operations within the multi-core processor 100E from operation by an initially “currently operating” second processor core 460 to operation of the first processor core 450 will be described with reference to FIGS. 7 and 8.

The switch signal generator 470 may be used to generate a selection signal SEL based on the second control signal CTRL2 provided by the second processor core 460.

In response to the selection signal SEL, a first selector 471 generates communication paths between the first instruction fetch unit 451 of the first processor core 450 and the shared-L1 cache 480.

Accordingly, the first instruction fetch unit 451 may communicate with a level 1-instruction cache (L1-Icache) 481 of the shared-L1 cache 480 and a level 1-instruction translation look-aside buffer (L1-ITLB) 483.

In addition, in response to the selection signal SEL, a second selector 473 generates communication paths between the out-of-order execution data units 453 and the shared-L1 cache 480. Accordingly, the out-of-order execution data units 453 may communicate with a level 1-data cache (L1-DCache) 487 and a level 1-data TLB (L1-DTLB) 489 of the shared-L1 cache 480 through the second selector 473.

The PMU 490 may be used to control the supply of a first power signal PWR1 to the first processor core 450, the supply of a second power signal PWR2 to the second processor core 460, and the supply of a third power signal PWR3 to the shared-L1 cache 480 based on the second control signal CTRL2 provided by the second processor core 460.

For example, the PMU 490 may block the second power signal PWR2 supplied to the second processor core 460 and supply the first power signal PWR1 to the first processor core 450 at appropriate times. Here, the PMU 490 may maintain the third power signal PWR3 supplied to the shared-L1 cache 480.

Such appropriate times may be defined in consideration of the respective operations of the first processor core 450 and the second processor core 460. For example, taking into consideration certain power stability and/or power consumption factors, certain time periods may be defined to interrupt the supply of the second power signal PWR2 to the second processor core 460, and/or the supply of the first power signal PWR1 to the first processor core 450.

According to certain embodiments of the inventive concept, in order to facilitate faster switching between cores, once the first power signal PWR1 has been stably supplied to the first processor core 450, the second power signal PWR2 supplied to the second processor core 460 may be interrupted.

In FIG. 8, each one of the first and second selectors 471 and 473 is shown as a physically separate circuit from the shared-L1 cache 480. However, one or both of the first and second selectors 471 and 473 may be included in (i.e., integrated within) the shared-L1 cache 480. Hence, in certain embodiments of the inventive concept, a shared-L1 cache 480 may be generically used that includes first and second selectors 471 and 473. In certain embodiments of the inventive concept, the first and second selectors 471 and 473 may be embodied as a multiplexer.

Now, FIGS. 7 and 8 will be used to describe a process of switching from the “currently-operating” first processor core 450 back to the second processor core 460.

The switch signal generator 470 may be used to generate the selection signal SEL now based on the first control signal CTRL1 provided by the currently-operating first processor core 450.

In response to the selection signal SEL, the first selector 471 may be used to generate communication paths between the instruction fetch unit 461 of the second processor core 460 and the shared-L1 cache 480. Accordingly, the second instruction fetch unit 461 may communicate with the level 1-instruction cache (L1-ICache) 481 and the level 1-instruction TLB (L1-ITLB) 483 of the shared-L1 cache 480 through the first selector 471.

In addition, in response to the selection signal SEL, the second selector 473 may generate communication paths between sequential execution data units 463 of the second processor core 460 and the shared-L1 cache 480.

Accordingly, the sequential execution data units 463 may communicate with the level 1-data cache (L1-DCache) 487 and the level 1-data TLB (L1-DTLB) 489 of the shared-L1 cache 480 through the second selector 473. A level two-TLB 485 (L2-TLB) may communicate with the level 1-instruction TLB (L1-ITLB) 483 and the level 1-data TLB (L1-DTLB) 489.

Each of the level 1-instruction cache (L1-ICache) 481, the level 2-TLB (L2-TLB) 485, and the level 1-data cache (L1-DCache) 487 may communicate with the sequential execution data units 463.

The PMU 490 may control the supply of the first power signal PWR1 to the first processor core 450, the supply of the second power signal PWR2 to the second processor core 460, and the supply of the third power signal PWR3 to the shared-L1 cache 480 based on the first control signal CTRL1 provided by the first processor core 450.

For example, PMU 490 may interrupt the first power signal PWR1 supplied to the first processor core 450, and the second power signal PWR2 supplied to the second processor core 460 at appropriate times. Here, the PMU 490 may maintain the third power signal PWR3 supplied to the shared-L1 cache 480.

As already suggested, such appropriate times (i.e., control timing for the various power signals) may be designed in consideration of the operation of the first processor core 450 and the second processor core 460. For example, considering power stability and/or power consumption, predetermined time(s) after the first power signal PWR1 has been supplied to the first processor core 450 and/or the second power signal PWR2 has been supplied to the second processor core 460 may be defined.

According to certain embodiments, in order to facilitate faster core switching, after the second power signal PWR2 has been stably supplied to the second processor core 460, the first power signal PWR1 supplied to the first processor core 450 may be interrupted.

As described above, the selection signal generation circuit 470 may be used to generate a selection signal SEL based on first and/or second control signals CTRL1 CTRL2 respectively provided by the first processor core 450 and the second processor core 460 during respective “currently-operating periods” for each processor core.

The level 1-instruction cache (L1-ICache) 481 and the level 1-instruction TLB (L1-ITLB) 483 are shared between the first processor core 450 and the second processor core 460. In addition, the level 1-data cache (L1-DCache) 487 and the level 1-data TLB (L1-DTLB) 489 are shared between the first processor core 450 and the second processor core 460. Accordingly, the switching overhead between the first and second processor cores 450 and 460 may be decreased, thereby reducing the memory access latency that occurs as a result of processor core switching operations.

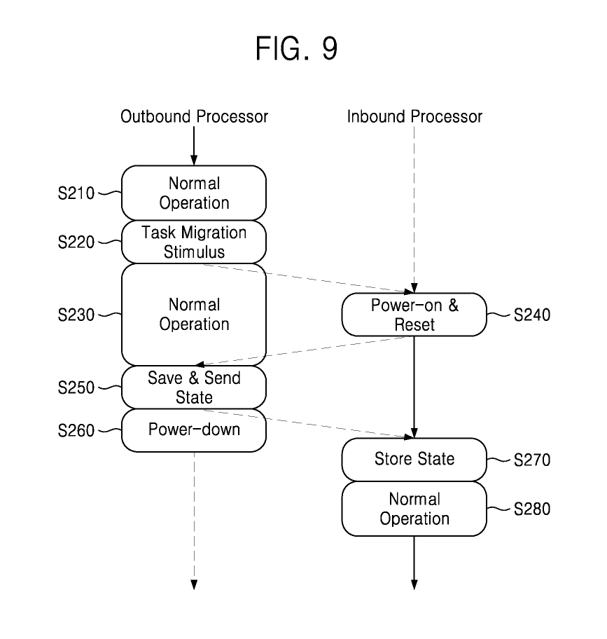

FIG. 9 is a flowchart summarizing a core switching approach that may be used by the multi-core processor of FIG. 7. Referring to FIGS. 7, 8 and 9, each of the first and second processor cores 450 and 460 shares related component 481, 483, 485, 487, and 489 associated with the L1 Cache 480. As such, various operations conventionally necessary to maintaining data coherence in the L1 Cache 480 are unnecessary and processor core switching delay time may be reduced.

For example, operations for maintaining consistency of software data, e.g., initialization of each component 481, 483, 485, 487, and 489, and a cache clean-up operation of an outbound processor core, are removed. As another example, operations for maintaining consistency of hardware data, e.g., initialization of each component 481, 483, 485, 487, and 489, a cache clean-up operation of the outbound processor core, and cache snooping, are removed.

The outbound processor core denotes a processor core which is currently operating, and an inbound processor core denotes a processor core to be operated according to a core switch.

When the outbound processor core is normally operating (S210), if task migration stimulus occurs or is performed by an operating system (OS) (S220), the inbound processor core performs a power-on reset (S240).

The outbound processor core continuously performs a normal operation (S230), in response to preparation for a task movement output from the inbound processor core, the outbound processor core stores data necessary for storage (or to store) in a corresponding memory and transmits data necessary for transmission to the inbound processor core (S250).

The data necessary for transmission are all transmitted from the outbound processor core to the inbound processor core, the outbound processor core is powered-down (S260). The memory may be the level 1-data cache 487 or another level of memory. Data stored in the memory may include a start address of a task to be performed next.

The inbound processor core receives data transmitted from the outbound processor core and stores the received data in a corresponding memory (S270), and performs a normal operation (S280).

A processor core switching is performed from the outbound processor core to the inbound processor core through steps S210 to S280 described above.

Also as described above, each one of the first and second processor cores 450 and 460 shares each component 481, 483, 485, 487, and 489 associated with the L1 cache 480, and accordingly the above-mentioned operations for maintaining data consistency are not necessary and processor core switching delay time may be reduced.

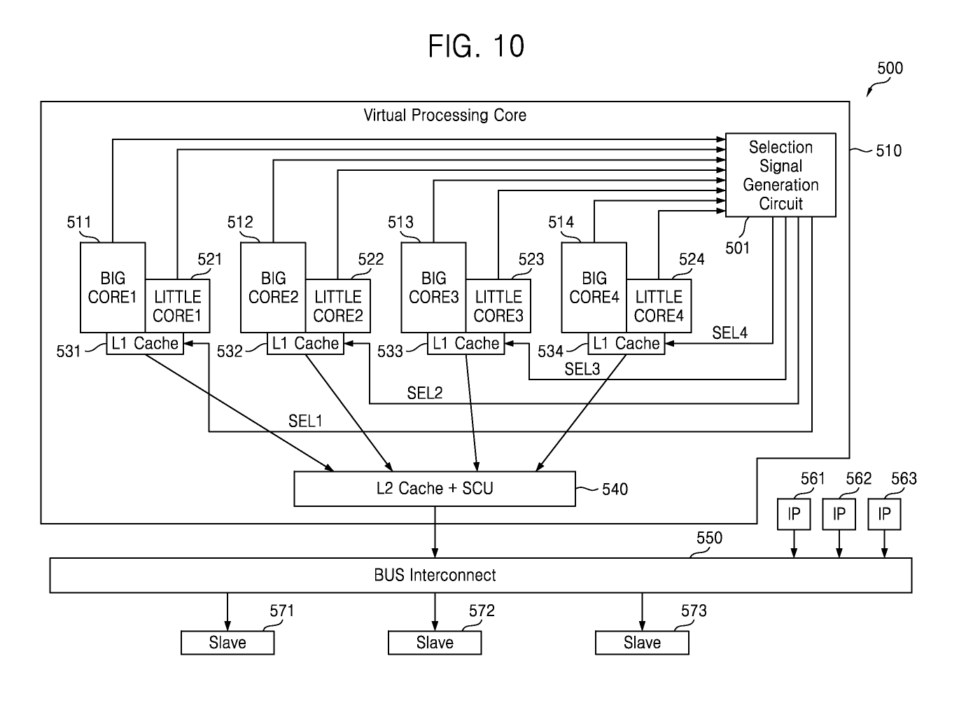

FIG. 10 is a block diagram illustrating a system including the multi-core processor of FIG. 7 according to certain embodiments of the inventive concept. Referring to FIG. 10, a system 500 includes a multi-core processor (i.e., virtual processing core) 510, a bus interconnect 550, a plurality of intellectual properties (IPs) 561, 562, and 563, and a plurality of slaves 571, 572, and 573.

The virtual processing core 510 includes a plurality of big processor cores 511, 512, 513, and 514, a plurality of little processor cores 521, 522, 523, and 524, and a level two cache & snoop control unit (SCU) 540.

Each of the plurality of big processor cores 511, 512, 513, and 514 and each of the plurality of little processor cores 521, 522, 523, and 524 may constitute a pair or a group. The pairs may form a processing cluster. Each of the plurality of IPs 561, 562, and 563 does not include a cache.

Each of the plurality of big processor cores 511, 512, 513, and 514 corresponds to the first processor core 450 illustrated in FIG. 7, each of the plurality of little processor cores 521, 522, 523, and 524 corresponds to the second processor core 460 illustrated in FIG. 7, and each of the shared-L1 caches 531, 532, 533, and 534 corresponds to the shared-L1 cache 480 illustrated in FIG. 7.

The selection signal generation circuit 501 may generate a corresponding selection signal SEL1, SEL2, SEL3, and SEL4 in response to a control signal output from each of the plurality of big processor cores 511, 512, 513, and 514 and a control signal output from each of the plurality of little processor cores 521, 522, 523, and 524.

For example, a big processor core 511 and a little processor core 521 may share a shared-L1 531. One of the big processor core 511 and the little processor core 521 may access the shared-L1 cache 531 in response to the first selection signal SEL1

A big processor core 514 and a little processor core 524 may share a shared-L1 cache 534. One of the big processor core 514 and the little processor core 524 may access the shared-L1 cache 534 in response to a fourth selection signal SEL4.

The level two cache & SCU 540 may communicate with each shared-L1 cache 531, 532, 533, and 534. The level two cache & SCU 540 may communicate with at least one IP 561, 562, and 563, or at least one slave 571, 572, and 573.

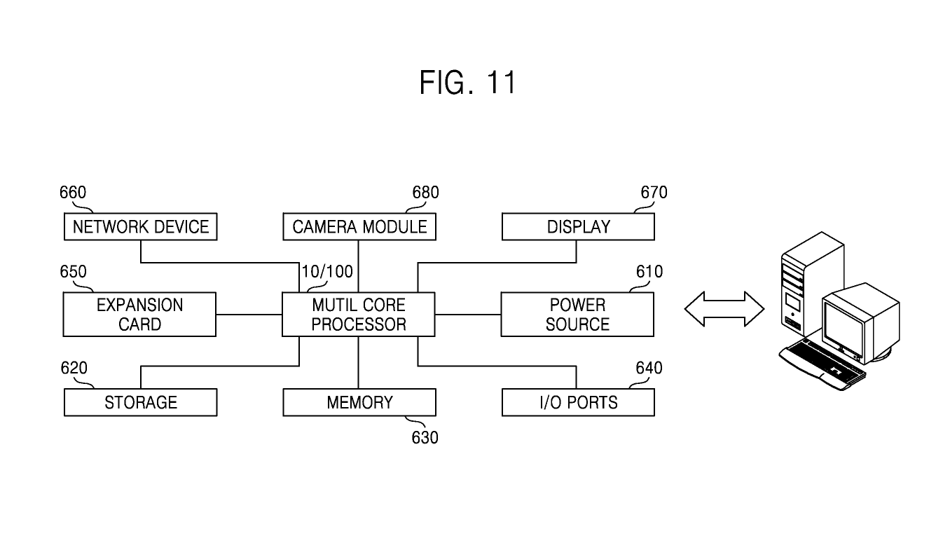

FIG. 11 is a block diagram illustrating a data processing device including a multi-core processor like the ones described in relation to FIGS. 1, 2, 3, 4, 5 and 7. Referring to FIG. 11, the data processing device may be embodied in a personal computer (PC) or a data server.

The data processing device includes a multi-core processor 10 or 100, a power source 510, a storage device 520, a memory 530, input/output ports 540, an expansion card 550, a network device 560, and a display 570. According to an example embodiment, the data processing device may further include a camera module 580.

The multi-core processor 10 or 100 may be embodied in one of the multi-core processor 10, 100A to 100D (collectively 100) illustrated in FIGS. 1 to 5 and 7. The multi-core processor 10 or 100 including at least two processor cores includes an L1 cache shared by each of the at least two processor cores. Each of the at least two processor cores may access the L1 cache exclusively.

The multi-core processor 10 or 100 may control an operation of each element 10, 100, 520 to 580. A power source 510 may supply an operating voltage to the each element 10, 100, 520 to 580. A storage device 520 may be embodied in a hard disk drive or a solid state drive (SSD).

The memory 530 may be embodied in a volatile memory or a non-volatile memory. According to an example embodiment, a memory controller which may control a data access operation of the memory 530, e.g., a read operation, a write operation (or a program operation), or an erase operation, may be integrated or built in the multi-core processor 10 or 100. According to an example embodiment, the memory controller may be embodied in the multi-core processor 10 or 100 and the memory 530.

The input/output ports 540 mean ports which may transmit data to a data storage device or transmit data output from the data storage device to an external device.

The expansion card 550 may be embodied in a secure digital (SD) card or a multimedia card (MMC). According to an example embodiment, the expansion card 550 may be a Subscriber Identification Module (SIM) card or a Universal Subscriber Identity Module (USIM) card.

The network device 560 means a device which may connect a data storage device to a wire network or wireless network.

The display 570 may display data output from the storage device 520, the memory 530, the input/output ports 540, the expansion card 550 or the network device 560.

The camera module 580 means a module which may convert an optical image into an electrical image. Accordingly, an electrical image output from the camera module 580 may be stored in the storage device 520, the memory 530 or the expansion card 550. In addition, an electrical image output from the camera module 580 may be displayed through the display 570.

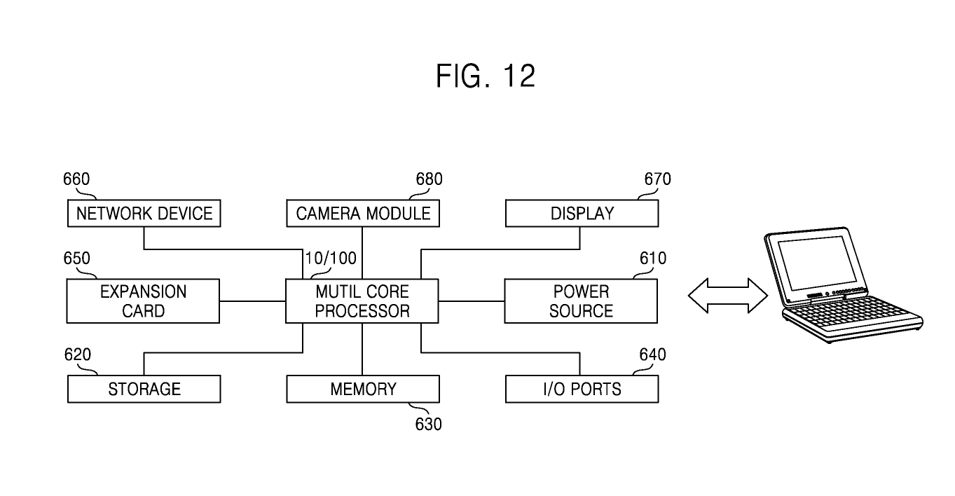

FIG. 12 is a block diagram illustrating another data processing device including a multi-core processor like the ones described in relation to FIGS. 1, 2, 3, 4, 5 and 7. Referring to FIGS. 11 and 12, the data processing device of FIG. 12 may be embodied in a laptop computer.

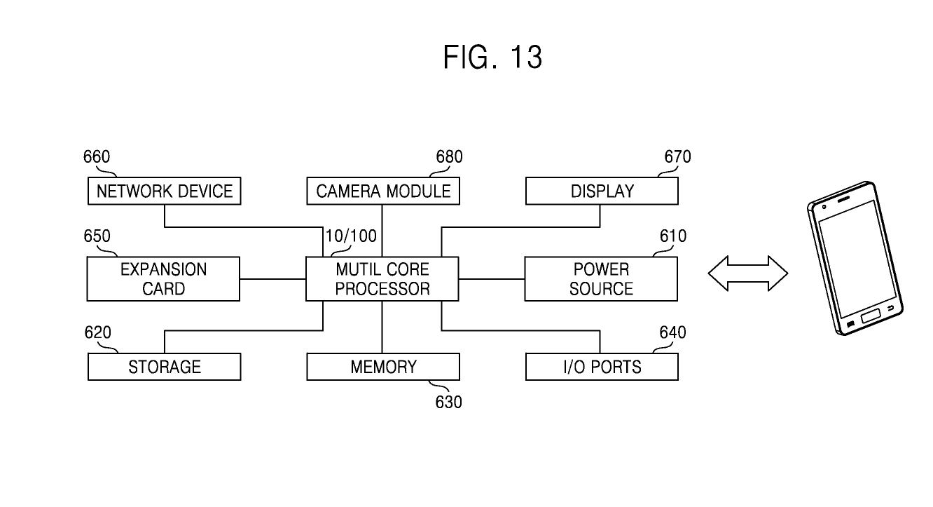

FIG. 13 is a block diagram illustrating still another data processing device including a multi-core processor like the ones described in relation to FIGS. 1 to 5 and 7. Referring to FIGS. 11 and 13, a data processing device of FIG. 13 may be embodied in a portable device. The portable device may be embodied in a cellular phone, a smart phone, a tablet PC, a personal digital assistant (PDA), an enterprise digital assistant (EDA), a digital still camera, a digital video camera, a portable multimedia player (PMP), a personal navigation device or a portable navigation device (PND), a handheld game console, or an e-book.

Each of at least two processor cores integrated to a multi-core processor according to an embodiment of the inventive concepts may share an L1 cache integrated to the multi-core processor.

Accordingly, a processor core operating at a relatively low frequency among the at least two processor cores may share and use an L1 cache integrated to a processor core operating at a relatively high frequency among the at least two processor cores, so that it may increase an operating frequency of the processor operating at a low frequency. Additionally, as an L1 cache is shared, CPU scaling or CPU switching may be possible during a specific task.

Although a few embodiments of the inventive concept have been shown and described, it will be appreciated by those skilled in the art that changes may be made in these embodiments without departing from the scope of the inventive concept defined by the appended claims and their equivalents.

What is claimed is:

1. A multi-core processor comprising:
a first processor core including a first instruction fetch unit and out-of-order execution data units;
a second processor core including a second instruction fetch unit and in-order execution data units; and
a shared-level 1 cache including a level 1-instruction cache shared between the first instruction fetch unit and the second instruction fetch unit and a level 1-data cache shared between the out-of-order execution data units and the in-order execution data units.

2. The multi-core processor of claim 1, further comprising:
a first selector that generates a communication path between one of the first instruction fetch unit and the second instruction fetch unit and the level 1-instruction cache in response to a selection signal; and
a second selector that generates a communication path between one of the out-of-order execution data units and the in-order execution data units and the level 1-data cache in response to the selection signal.

3. The multi-core processor of claim 2, further comprising a selection signal generation circuit that generates the selection signal in response to at least one of a first control signal provided by the first processor core and a second control signal provided by the second processor core.

4. The multi-core processor of claim 2, wherein the first selector is a multiplexer that receives inputs from the first instruction fetch unit and the second instruction fetch unit and provides at least one output to the shared level-1 cache.

5. The multi-core processor of claim 4, wherein the second selector is a multiplexer that receives inputs from the out-of-order execution data units and the in-order execution units and provides at least one output to the shared level-1 cache.

6. The multi-core processor of claim 5, wherein the first processor core further includes:
a first branch prediction unit communicating a first instruction to the first instruction fetch unit;
a first decoder unit that receives and decodes the first instruction to generate a decoded first instruction; and
a register renaming and dispatch unit that provides control signals to the out-of-order execution data units in response to the decoded first instruction.

7. The multi-core processor of claim 6, wherein the second processor core further includes:
a second branch prediction unit communicating a second instruction to the second instruction fetch unit;
a second decoder unit that receives and decodes the second instruction to generate a decoded second instruction; and
a dispatch unit that provides control signals to the in-order execution data units in response to the decoded second instruction.

8. The multi-core processor of claim 1, further comprising:
a power management unit that selectively provides a first power signal to the first processor core, selectively provides a second power signal to the second processor core, and provides a third power signal to the shared-level 1 cache.

9. The multi-core processor of claim 8, further comprising:
a first selector that generates a communication path between one of the first instruction fetch unit and the second instruction fetch unit and the level 1-instruction cache in response to a selection signal; and
a second selector that generates a communication path between one of the out-of-order execution data units and the in-order execution data units and the level 1-data cache in response to the selection signal.

10. The multi-core processor of claim 9, further comprising a selection signal generation circuit that generates the selection signal in response to at least one of a first control signal provided by the first processor core and a second control signal provided by the second processor core.

11. The multi-core processor of claim 10, wherein the first control signal and the second control signal are supplied to the power management unit, and
the power management unit determines the selective provision of the first power signal to the first processor core, and the selective provision of the second power signal to the second processor core in response to the first and second control signals.

12. The multi-core processor of claim 11, wherein the selective provision of the first power signal to the first processor core occurs at least when the first processor core is currently operating, and the selective provision of the second power signal to the second processor core occurs at least when the second processor core is currently operating.

13. The multi-core processor of claim 11, wherein the second processor core consumes relatively less power than the first processor core per unit of operating time.

14. A system comprising:
a bus interconnect connecting a slave device with a virtual processing device, wherein the virtual processing device comprises:
a first multi-core processor group having a first level-1 cache;
a second multi-core processor group having a second level-1 cache;
a selection signal generation circuit, wherein a first output is provided by the first level-1 cache in response to a first selection signal provided by the selection signal generation circuit, and a second output is provided by the second level-1 cache in response to a second selection signal provided by the selection signal generation circuit; and
a level-2 cache that receives the first output from the first level-1 cache and the second outputs from the second level-1 cache, and provides a virtual processing core output to the bus interconnect.

15. The system of claim 14, wherein the first multi-core processor group comprises:
a first big core including a first instruction fetch unit and out-of-order execution data units and a first little processor core including a second instruction fetch unit and in-order execution data units, wherein the first level-1 cache is a shared-level 1 cache including a level 1-instruction cache shared between the first instruction fetch unit and the second instruction fetch unit and a level 1-data cache shared between the out-of-order execution data units and the in-order execution data units.

16. The system of claim 15, wherein the selection signal generation circuit is configured to generate the first and second selection signals in response to a first control signal provided by the first big processor core and a second control signal provided by the first little processor core.

17. A method of operating a multi-core processor, the method comprising:
generating a first control signal from a first processor core including a first instruction fetch unit and out-of-order execution data units;
generating a second control signal from a second processor core including a second instruction fetch unit and in-order execution data units;
sharing a level 1-instruction cache of a single shared level-1 cache between the first instruction fetch unit and the second instruction fetch unit and sharing a level 1-data cache of the shared level-1 cache between the out-of-order execution data units and the in-order execution data units.

18. The method of claim 17, further comprising:
generating a first communication path through a first selector between one of the first instruction fetch unit and the second instruction fetch unit and the level 1-instruction cache in response to a selection signal; and
generating a second communication path through a second selector between one of the out-of-order execution data units and the in-order execution data units and the level 1-data cache in response to the selection signal.

19. The method of claim 18, further comprising:
generating the selection signal in response to at least one of the first control signal provided by the first processor core and the second control signal provided by the second processor core.

20. The method of claim 19, wherein the first control signal is generated by the first processor core only during currently operating periods for the first processor core, and the second control signal is generated by the second processor core only during currently operating periods for the second processor core.
